(19) United States
(12) Patent Application Publication
(10) Pub. No.: US 2011/0123884 A1
(43) Pub. Date: May 26, 2011

(54) METHOD FOR CONTROLLING A FUEL CELL SYSTEM DURING SHUTDOWN

(75) Inventors: Nathan Ernst, Ann Arbor, MI (US); John Muczynski, Ypsilanti, MI (US); Mike Gorski, Dexter, MI (US)

(73) Assignee: ADAPTIVE MATERIALS, INC., Ann Arbor, MI (US)

(21) Appl. No.: 12/624,951

(22) Filed: Nov. 24, 2009

(51) Int. Cl. H01M 8/00

(52) U.S. Cl. 429/429; 429/454

(57) ABSTRACT

A method for controlling a fuel cell system comprising a fuel cell stack is described in accordance with exemplary embodiments. The method includes operating the fuel cell system in a base operating mode. The method further includes drawing power from the fuel cell stack at a controlled rate when operating the fuel cell system in the base operating mode. The method further includes receiving a fuel cell stack shutdown command. The method further includes transitioning the fuel cell stack from the base operating mode to a base shutdown mode when the fuel cell stack shutdown command is received. The base shutdown mode includes discontinuing power draw from the fuel cell stack and providing fuel to the fuel cell stack at a controlled fuel flow rate. The fuel flow rate being controlled such that the fuel cell stack temperature decreases.

### BACKGROUND

The statements in this section merely provide background information related to the present disclosure and may not constitute prior art.

Solid oxide fuel cells (‘SOFCs’) can convert fuel to electricity at higher efficiencies than traditional energy conversion devices. Further, SOFCs are highly desirable as a power source because SOFCs are highly robust, provide high energy and high power densities, and generate low levels of undesirable emissions.

SOFCs create an electromotive force across an electrolyte by reacting a fuel, typically hydrogen, at an anode disposed on a first side of the electrolyte, and an oxidant, typically oxygen at a cathode disposed on a second side of the electrolyte. SOFCs operate at temperatures ranging from 600-950° C. At the operating temperatures of SOFCs, an oxidative environment can degrade operational performance of the anode and a reducing environment can degrade operational performance of the cathode.

Further, an internal reformer can be utilized within a fuel cell stack to reform hydrocarbon fuels (such as, propane, butane, and JP-8) to fuels suitable for electrochemical reactions in SOFC anodes. Oxygen is provided to reform the hydrocarbon fuels. In order to operate efficiently, prevent anode oxidation, and prevent coke formation, the oxygen-to-fuel ratio at the internal reformer must be controlled within an oxygen-to-fuel ratio window.

Current fuel systems are designed to utilize high speed pumps and operate at high internal pressure levels to control air and fuel ratios within the solid oxide fuel cell stack to desired levels. However, low pressure fuel cells are highly desirable in that low pressure fuel cells have increased durability and lower component costs. Further, replacing high speed pumps with blowers can significantly reduce fuel cell system cost. Current control methods cannot sufficiently control air and fuel flow rates in low pressure fuel cells during shutdown to sufficiently protect the fuel cell system from coking, anode oxidation, cathode reduction, and thermal shock. Therefore, methods for controlling are needed to improve fuel cell durability for low pressure, low cost fuel cell systems.

### DESCRIPTION OF DRAWINGS

FIGS. 1 and 2 are schematic power and signal flow diagrams of a fuel cell system in accordance with an exemplary embodiment of the present disclosure and

FIG. 3 is a flow chart diagram of a method for controlling a fuel cell system.

It should be understood that the appended drawings are not necessarily to scale, presenting a somewhat simplified representation of various preferred features illustrative of the basic principles of the invention. The specific design features of the fuel cell systems as disclosed here will be determined in part by the particular intended application and use environment. Certain features of the illustrated embodiments have been enlarged or distorted relative to others for visualization and clear understanding. In particular, thin features may be thickened, for example, for clarity of illustration.

### SUMMARY

A method for controlling a fuel cell system comprising a fuel cell stack is described in accordance with exemplary embodiments. The method includes operating the fuel cell system in a base operating mode. The method further includes drawing power from the fuel cell stack at a controlled rate when operating the fuel cell system in the base operating mode. The method further includes receiving a fuel cell stack shutdown command. The method further includes transitioning the fuel cell stack from the base operating mode to a base shutdown mode when the fuel cell stack shutdown command is received. The base shutdown mode includes discontinuing power draw from the fuel cell stack and providing fuel to the fuel cell stack at a controlled fuel flow rate. The fuel flow rate being controlled such that the fuel cell stack temperature decreases.

### DETAILED DESCRIPTION

A method for controlling a fuel cell system is described herein. In particular, the exemplary method and other alternate embodiments thereof, as defined in the claims, can extend fuel cell stack operating lifespan over the stack lifespan of fuel cell stacks utilizing current control methods. Further, the exemplary methods and other alternate embodiments thereof can effectively control fuel cell stacks utilizing blowers and fuel cell stacks operating at low pressure levels, that is, pressures levels at or about atmospheric pressure.

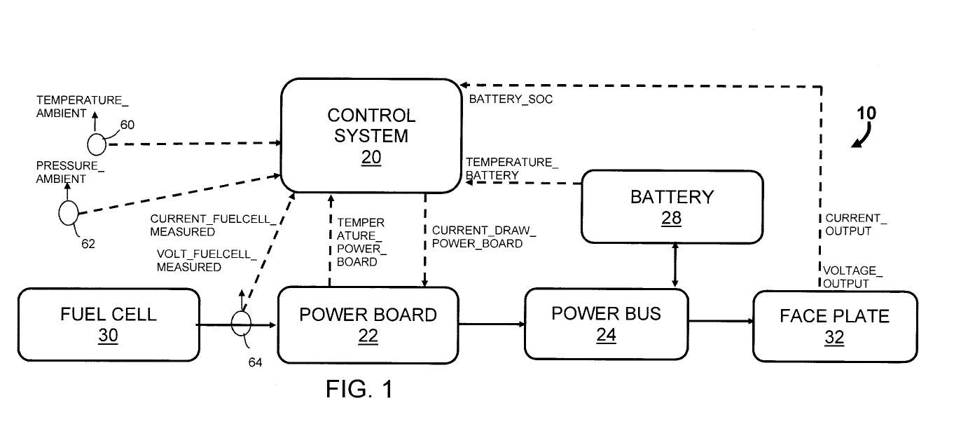

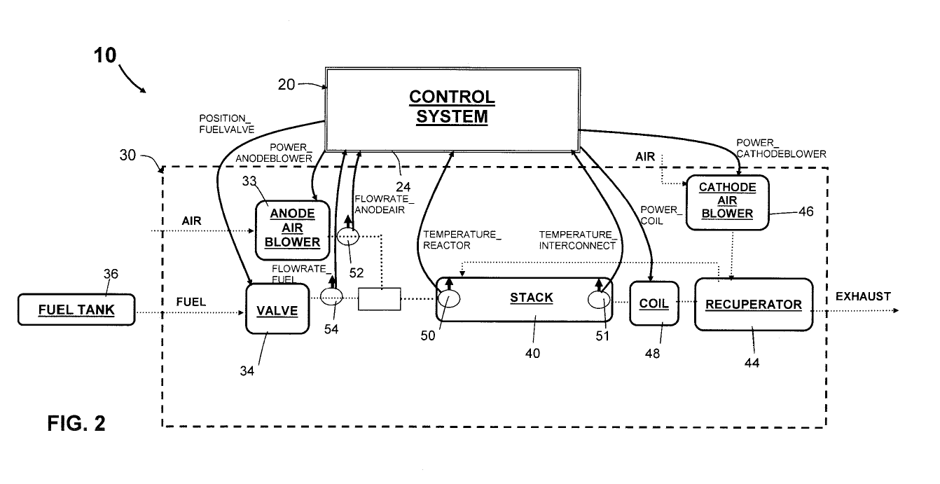

Referring to FIG. 1 and FIG. 2, a fuel cell system 10 is configured to convert fuel to electric power. The fuel cell system 10 includes a control system (‘CONTROL SYSTEM’) 20, a power board (‘POWER BOARD’) 22, a power bus (‘POWER BUS’) 24, a rechargeable battery (‘BATTERY’) 28, a fuel cell module (‘FUEL CELL MODULE’) 30, and a face plate (FACE PLATE) 32.

The control system 20 comprises a microprocessor configured to execute a set of control algorithms, comprising resident program instructions and calibrations stored in storage mediums to provide the respective control functions. The control system 20 can monitor input signals from sensors disposed throughout the fuel cell system 10, some of which are described in detail herein below and can execute algorithms in response to the monitored input signals to execute routines to control power flows and component operations of the fuel cell system 10.

The power board 22 converts a fuel cell voltage level (‘VOLT_FUELCELL MEASURED’) and corresponding fuel cell electric current (‘AMPFUELCELL_MEASURED’) to an output voltage level corresponding to output voltage (‘VOLTAGE OUTPUT’) measured at the faceplate 32. Voltage conversion levels between the fuel cell voltage and the primary system voltage can be controlled at the power board 22 and can be adjusted by the control system 20 based on monitored power levels through commands (AMPDRAW_POWERBOARD) from the control system 20. Further, the control system 20 monitors a temperature (‘TEMPERATURE POWERBOARD’) from temperature sensor (not shown) of power board 22.

The power bus 24 comprises an electrically conductive network configured to route power from the energy conversion devices (the rechargeable battery 28 and the fuel cell module 30) to the face plate 32. The face plate 32 comprises a plurality of power ports for connecting external devices to the fuel cell system 10.

The exemplary rechargeable battery 28 is a rechargeable battery configured to receive power from the power bus 24 and to discharge power to the power bus 24. The rechargeable battery 28 can comprise any of several rechargeable battery technologies including, for example, nickel-cadmium, nickel-metal hydride, lithium-ion, and lithium-sulfur technologies. In alternative embodiments, other reversibly energy storage technologies such as ultra-capacitors can be utilized in addition to or instead of the rechargeable battery 28. Further, in alternate embodiments, multiple energy storage devices can be utilized within a fuel cell system 10. The control system 20 receives information from internal sensors within the battery 28 monitoring battery state of charge (‘BATTERY_SOC’) and temperatures (‘TEMPERATURE BATTERY’) at varied locations of the battery 28.

The fuel tank 36 contains a fuel for use by the fuel cell module 30. Exemplary fuels include a wide range of hydrocarbon fuels. In an exemplary embodiment, the fuel comprises an alkane fuel and specifically, propane fuel. In alternative embodiments, the fuel can comprise one or more other types of alkane fuel, for example, methane, ethane, propane, butane, pentane, hexane, heptane, octane, and the like, and can include non-linear alkane isomers. Further, other types of hydrocarbon fuel, such as partially and fully saturated hydrocarbons, and oxygenated hydrocarbons, such as alcohols and glycols, can be utilized as fuel that can be converted to electrical energy by the fuel cell module 30. The fuel also can include mixtures comprising combinations of various component fuel molecules examples of which include gasoline blends, liquefied natural gas, JP-8 fuel and diesel fuel.

Referring to FIG. 2, the exemplary fuel cell module 30 includes a fuel cell stack 40 (‘STACK’), an anode air blower 33 (‘ANODE AIR BLOWER’), a cathode air blower 46 (‘CATHODE AIR BLOWER’), a fuel valve 34 (‘VALVE’), and a recuperator 44 (‘RECUPERATOR’) disposed within an insulative body 42. The insulative body 42 comprises porous thermally insulative material capable of withstanding the operating temperatures of the fuel cell stack 40, that is, temperatures of up to 1000 degrees Celsius. Exemplary materials for the insulative body 42 can include high-temperature, ceramic-based material comprising high-surface area foam, mat-materials, and fibers made from, for example, alumina, silica, and like materials. The recuperator 44 comprises a heat exchange manifold for transferring heat from fuel cell exhaust gas to air inputted to the fuel cell stack 40.

The fuel cell stack 40 further includes a plurality of sensors providing signals to the control system 20. Signals monitored by the control system 20 include actual fuel flow rate (‘FLOWRATE_FUEL’) from fuel flow rate sensor 54, an actual anode air flow rate (‘FLOWRATE_ANODEAIR’) from anode air flow rate sensor 52, a reactor temperature (‘TEMPERATURE_REACTOR’) from a temperature sensor 50 proximate internal reformation reactors disposed within fuel cell tubes of the fuel cell stack 40, and an interconnect temperature (‘TEMPERATURE_INTERCONNECT’) from a temperature sensor 52 disposed proximate interconnect members at the exhaust ends of fuel cell tubes of the fuel cell stack 40. The control system 20 is configured to provide signals to send commands to components actuators of the fuel cell stack 40. The signals include a valve position (‘POSITION_FUELVALVE’), an anode air blower power level (‘POWER_ANODEBLOWER’), coil power (‘POWER_COIL’), and a cathode air blower power level (‘POWER_CATHODEBLOWER’).

The cathode air blower 46 moves ambient air through the recuperator 44 and into the fuel cell module 30 and an exhaust fan (not shown) pulls exhaust gases ('EXHAUST') away from the fuel cell module 30. The fuel valve 34 controls fuel flow from the fuel tank 32 into the fuel cell stack 40 and the anode air blower 52 moves ambient air into the fuel cell stack 40, wherein the ambient air and fuel are combined and reacted within an internal reformer (not shown). The coil 48 comprises a resistant heating coil 48 that can heat fuel and air that pass through the fuel cell stack 40 to combust the air and fuel.

The fuel cell stack 40 comprises a plurality of solid oxide fuel cell tubes, along with various other components, for example, air and fuel delivery manifolds, current collectors, interconnects, and like components for routing fluid and electrical energy to and from the component cells within the fuel cell stack 40. The solid oxide fuel cell tubes electrochemically transform the fuel gas into electricity and exhaust gases. The actual number of solid oxide fuel cell tubes depends in part on size and power producing capability of each tube and the desired power output of the SOFC. Each solid oxide fuel cell includes an internal reformer disposed therein. The internal reformer can react raw fuel from the fuel tank 36 to reform the fuel such that the reformed fuel can be reacted at an anode of the fuel cell tube.

The exemplary fuel cell module 30 is a solid oxide fuel cell comprising several component cells, along with various other components, for example, air and fuel delivery manifolds, current collectors, interconnects, and like components, for routing fluid and electrical energy to and from the component cells within the fuel cell 30. In alternative embodiments, other types of fuel cell technology such as proton exchange membrane (PEM), alkaline, direct methanol, and the like can be utilized within the hybrid energy storage device 10 instead of or addition to solid oxide fuel cells. Further, as mentioned above, in alternative embodiments, the hybrid energy conversion system can comprise various other energy conversion devices in addition to or instead of the fuel cell module 30.

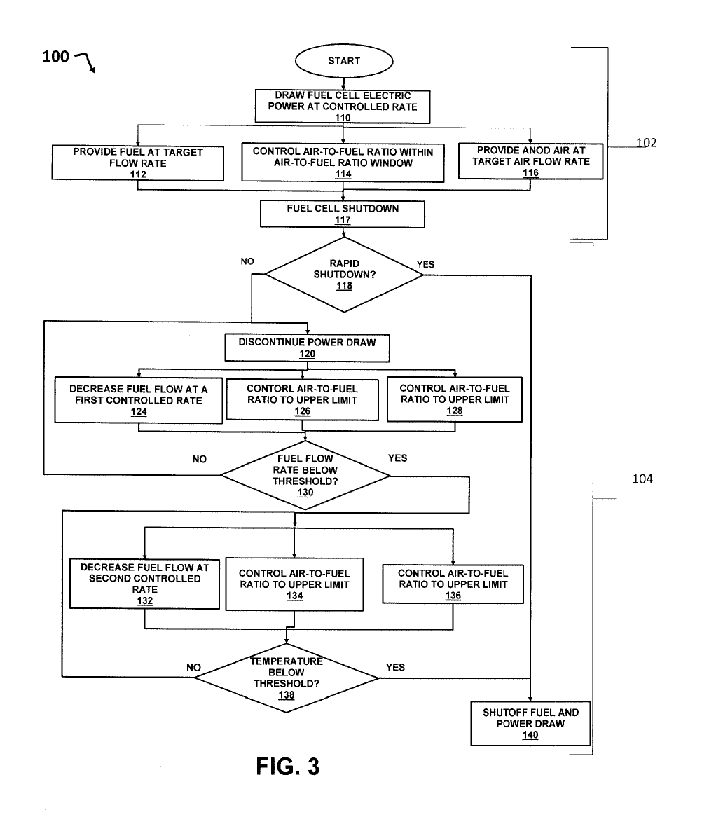

Referring to FIG. 3, a method 100 for controlling a fuel cell system 10 comprises a method for controlling the fuel cell system in a base operating mode 102 and a method for controlling a fuel cell system in a shutdown operating mode 104.

The base operating mode 102 is the standard operating mode for operating the fuel cell system 10 to provide external power. At step 110, the control system 20 determines a target current draw at the power board 22 and corresponding power board output voltage and the control system 20 sends a current draw command signal (‘CURRENT_DRAW_POWER_BOARD’) to the power board 22 to meet the target current draw. By controlling the target current draw and corresponding voltage levels of the power board 22, the control system 20 can control an electric power level generated at and drawn from the fuel cell stack 40 from a power draw level of approximately zero watts at an open circuit voltage to up a maximum fuel cell stack power level.

At steps 112 and 114, the control system 20 commands the fuel valve 34 to provide fuel at a controlled fuel rate. In particular, the control system 20 determines air-to-fuel ratio window based on reactor temperature (‘TEMPERATURE_REACTOR’). The air-to-fuel ratio window comprises a range from an upper air-to-fuel ratio limit to a lower air-to-fuel ratio limit, wherein the limits are determined to prevent anode oxidation and coking. The control system 20 determines a target fuel flow rate within the air-to-fuel ratio window based on a desired fuel utilization level, based on one of the reactor temperature and the interconnect temperature, and based on power board 22 current draw. The control system 20 utilizes feedback control based on the measured fuel flow rate (‘FLOWRATE_FUEL’) and the measured anode air flow rate (‘FLOWRATE’) measured at the fuel flow sensor 54 and the anode air flow sensor 52, respectively to provide fuel air at the controlled fuel air flow rate.

At step 116, the control system 20 controls the anode air blower 33 to provide anode air to the fuel cell stack 40 at a controlled air flow rate. In particular, the controls system 20 determines a target air flow rate based on a desire air-to-fuel ratio level and utilizes feedback control based on measured anode air flow rate (‘FLOWRATE_NODEAIR’) and the measured anode air flow rate (‘FLOWRATE’) measured at the fuel flow sensor 54 and the anode air flow sensor 52, respectively to provide anode air at the controlled anode air flow rate.

Although the term, “air-to-fuel ratio”, is utilized throughout the specification, the control system 20 utilizes the air-to-fuel ratio to determine a desired oxygen-to-fuel ratio for the reformation reaction, wherein other air components including such as nitrogen does not participate in the reforming reactions.

At step 117, the control system 20 determines a shutdown mode by detecting a shutdown event and transitions the fuel cell system 10 from the base operating mode 102 to the fuel cell shutdown operating mode 104. The shutdown mode transitions the fuel cell system 10 to an “off” or “hibernating” state thereby discontinuing power generation within the fuel cell stack 40 and conserving power stored within the battery 28. During the shutdown mode 102, the control system 20 controls components of the fuel cell system 10 to cool the fuel cell stack 40.

At step 118, the control system 20 determines a rapid shutdown mode 118 (‘YES’) or determines a base shutdown mode (‘NO’) based on the type of shutdown event that is detected (at step 117). When certain types of shutdown events are detected, it is desirable to perform one or more functions such as discontinuing power to balance-of-plant components, discontinuing fuel cell stack 40 fueling, and rapidly cooling the fuel cell stack 40, even if performing these functions will result in degraded operating life of the fuel cell stack 40. Therefore, the control system 20 will determine the rapid shutdown mode when detecting rapid shutdown events. Exemplary rapid shutdown events in which rapid shutdown mode is desirable includes detecting faults in multiple sensors, temperature measurements within the fuel cell system that are above temperature thresholds, and power measurements in the fuel cell system that are above power thresholds. If the control system 20 determines a rapid shutdown mode, the control system 20 commands the power board 22 to discontinue power draw from the fuel cell stack 40, and the control system 20 commands the anode air blower 33 to shutoff and the valve 34 to close, while maintaining the power to the cathode air blower to cool the fuel cell stack 40.

The base shutdown mode controls the fuel cell system 10 operation such that the fuel cell stack 40 cools down and at a controlled rate and such that appropriate reducing and oxidative environments are maintained at desired locations within the fuel cell stack 40. The control system 20 determines the base shutdown mode in response to a user input, for example a user flipping an “off” switch or pushing an “off button,” a system fault (for example, a sensor fault), low fuel detection, insufficient anode air detection, or an insufficient cathode air detection.

At step 120, the control system 20 commands the power board 22 to discontinue power draw from the fuel cell stack 30.

At steps 122 and 124, the control system 20 commands the fuel valve 34 to provide fuel at a controlled fuel rate. In particular, the control system 20 determines a target fuel flow rate within the air-to-fuel ratio window based a first precalibrated ramp-down profile and utilizes feedback control to provide fuel air at the controlled fuel air flow rate.

At step 126, the control system 20 commands the anode air blower 33 to provide anode air to the fuel cell stack 30 at a controlled air flow rate, decreasing the speed of the blower 33, thereby decreasing the air flow rate over time. The air flow rate is controlled to a target air-flow rate. The target air flow rate is determined base on the fuel flow rate and the air-to-fuel ratio upper limit of the air-to-fuel ratio window. By providing anode air and fuel the control system 20 provides a positive pressure through the fuel cell tube. By operating within the air-to-fuel ratio window, the control system 20 protects the anode from oxidation, but by utilizing the air-to-fuel ratio upper limit of the air-to-fuel ratio window, the fuel cell system 10 provides positive pressure while minimizing fuel cell heating caused by combustion reactions of the air and fuel.

At step 130, the control system 20 determines whether the measured fuel flow rate is below a fuel flow rate threshold. When the fuel flow rate is below the fuel flow rate threshold, the control system proceeds to steps 130, 132, and 134. When the fuel flow rate is above the fuel flow rate threshold, the control system returns to steps 120, 122, 124, and 126.

Steps 130, 132, and 134, are each similar to steps 122, 124, and 126, however, at step 130, the control system 20 determines a target fuel flow rate within the air-to-fuel ratio window based a second precalibrated ramp-down profile and utilizes feedback control to provide fuel air at the controlled fuel air flow rate. By utilizing multiple ramp down rates, the control system 20 can more rapidly decrease fuel and temperature during periods when precise air-to-fuel ratio control is not required to prevent oxidation and coking or thermal shock, or when precise air-to-fuel ratio control to compensate for sensor performance at certain flow rates, for example, very low rates. During the steps 128, 130, 132, and 134 the cathode air blower is operated to provide anode air flow at a controlled rate to maintain an oxidative environment at the cathodes of the fuel cell 40 and to continually cool the fuel cell stack 40.

At step 138, the control system 20 determines whether the reactor temperature is below a threshold temperature. When the reactor temperature is below the threshold temperature the control system proceeds to step 140. When the reactor temperature is above the threshold temperature, the control system repeats steps 130, 132, and 134.

Although the exemplary function utilizes two precalibrated control ramp down rates to control anode air and fuel flow within the fuel cell system 10, in alternate embodiments, one or several ramp down rates can be utilized. Algorithms utilized to control ramp down rates during the shutdown mode 104 can be a function of at least one of time, temperature, temperature change rate, anode air flow rate, fuel flow rate, anode blower power level, and fuel valve position.

The exemplary embodiments shown in the figures and described above illustrate, but do not limit, the claimed invention. It should be understood that there is no intention to limit the invention to the specific form disclosed; rather, the invention is to cover all modifications, alternative constructions, and equivalents falling within the spirit and scope of the invention as defined in the claims. Therefore, the foregoing description should not be construed to limit the scope of the invention.

1. A method for controlling a fuel cell system, the fuel cell system including a fuel cell stack, the method comprising:
operating the fuel cell system in a base operating mode;
drawing fuel cell stack power when operating the fuel cell system in the base operating mode;
receiving a base shutdown command; and
transitioning the fuel cell stack from the base operating mode to a fuel cell stack shutdown mode when the base shutdown command is received, the fuel cell stack shutdown mode comprising discontinuing power draw from the fuel cell stack and providing fuel to the fuel cell stack at a controlled fuel flow rate such that fuel cell stack temperature decreases.

2. The method of claim 1, wherein the fuel cell stack shutdown mode further comprises providing anode air to the fuel cell stack at a controlled anode air flow rate, wherein the fuel flow rate and the anode air flow rate are controlled such that the fuel cell stack temperature decreases over time, and wherein the fuel flow rate and the anode air flow rate are controlled within an oxygen-to-fuel ratio window, the oxygen-to-fuel ratio window comprising an oxygen-to-fuel ratio upper limit and an oxygen-to-fuel ratio lower limit.

3. The method of claim 2, further comprising controlling the anode air flow rate and the fuel flow rate at a first oxygen-to-fuel ratio when operating in the base operating mode and controlling the anode air flow rate and the fuel flow rate at a second oxygen-to-fuel ratio when operating in the shutdown operating mode, wherein the second oxygen-to-fuel ratio is greater than the oxygen-to-fuel ratio upper limit of the oxygen-to-fuel ratio window.

4. The method of claim 3, wherein second oxygen-to-fuel ratio is the oxygen-to-fuel ratio upper limit of the oxygen-to-fuel ratio window.

5. The method of claim 1, further comprising exothermically reacting the air and fuel in a catalytic reactor disposed within the fuel cell stack to reform the fuel, wherein an average fuel cell stack temperature decreases when the air and fuel are reacted in the catalytic reactor.

6. The method of claim 1, wherein the fuel flow rate decreases over time when the fuel cell stack operates in the shutdown mode.

7. The method of claim 1, wherein the fuel flow rate decreases at a rate based on a preconfigured profile when the fuel cell stack operates in the shutdown mode.

8. The method of claim 1, further comprising:
detecting a fuel cell stack temperature below a threshold temperature; and
shutting off fuel cell stack fueling when fuel cell stack temperature below the threshold temperature is detected.

9. A method for controlling a fuel cell system, the fuel cell system including a fuel cell stack generating electric power, a controller controlling fuel cell stack power draw, and an anode air blower providing anode air to the fuel cell stack, the method comprising:
receiving a shutdown command and
transitioning the fuel cell stack to the fuel cell stack shutdown mode when the fuel cell stack shutdown command is received, the fuel cell stack shutdown mode comprising:
discontinuing power draw from the solid oxide fuel cell stack and
providing fuel to the fuel cell stack when power draw is discontinued, said fuel level being controlled such that fuel cell stack temperature decreases over time.

10. The method of claim 9, further comprising detecting a rapid shutdown event and shutting off fuel to the fuel cell stack when the rapid shutdown event is detected.

11. The method of claim 9, further comprising providing power to the anode air blower when the rapid shutdown event is detected such that the anode air blower provides cooling air to the fuel cell stack.

12. The method of claim 9, further comprising:
providing anode air to the fuel cell stack at a controlled air flow rate when power draw is discontinued, the fuel flow rate and the anode air flow rate being controlled such that the stack temperature decreases over time, the fuel flow rate and the anode air flow rate being controlled within an oxygen-to-fuel ratio window, the oxygen-to-fuel ratio window comprising an oxygen-to-fuel ratio upper limit and an air-to fuel lower limit.

13. The method of claim 9, further comprising exothermically reacting the air and fuel in a catalytic reactor disposed within the fuel cell stack to reform the fuel, wherein the fuel cell stack temperature decreases over time when the air and fuel are reacted in the catalytic reactor.

14. The method of claim 9, wherein the fuel flow rate decreases over time when the fuel cell stack operates in the shutdown mode.

15. The method of claim 14, wherein the fuel flow rate decreases based on a preprogrammed profile when the fuel cell stack operates in the shutdown mode.

16. The method of claim 19, wherein the fuel flow rate decreases at a first selected rate until a first predetermined fuel flow rate is met, and the fuel flow rate decreases at a second selected rate when the fuel flow rate is below the first predetermined flow rate.

17. The method of claim 10, further comprising:
detecting a fuel cell stack temperature below a threshold temperature and shutting off fuel cell stack fueling when fuel cell stack temperature below the threshold temperature is detected.

18. A method for controlling a solid oxide fuel cell system during shutdown, the solid oxide fuel cell system including an anode air blower, the method comprising:
determining one of a base shutdown event and a rapid shutdown event;
providing fuel to the fuel cell when the base shutdown event is determined; and
discontinuing fuel to the fuel cell when the rapid shutdown event is determined.

19. The method of claim 18, further comprising determining the base shutdown event, wherein determining the base shutdown event comprises determining one of a user shutdown input, a sensor fault, a low fuel level, and a low air level.

20. The method of claim 18, wherein determining the rapid shutdown event comprises determining one of a temperature exceeding a temperature threshold and a power level exceeding a power level threshold.
